(19) United States
(12) Patent Application Publication
(10) Pub. No.: US 2025/0155025 A1
(43) Pub. Date: May 15, 2025

(54) Sealing arrangement, in particular mechanical seal, preferably for use in coolant units

(71) Applicant: KACO GmbH + Co. KG, Kirchardt (DE)

(72) Inventors: Andreas GENESIUS, Heilbronn (DE); Eckhard OGAZA, Obersulm (DE); Pascal VON DOBRZEWINSKI, Schwetzingen (DE)

(73) Assignee: KACO GmbH + Co. KG, Kirchardt (DE)

(21) Appl. No.: 18/838,630

(22) PCT Filed: Feb. 15, 2023
(86) PCT No.: PCT/EP2023/053809

§ 371 Date: Aug. 15, 2024

(30) Foreign Application Priority Data
Feb. 17, 2022 (DE) 10 2022 000 620.0

(51) Int. Cl. F16J 15/34

(52) U.S. Cl. CPC F16J 15/3464

(57) ABSTRACT

A sealing arrangement can be a mechanical face seal or a lip seal and has at least one sealing element (2) retained by at least one retaining element (20) that has an air-side and/or medium-side exterior. The exterior is provided with an air-tight and/or medium-tight complete or at least partial protective layer (45). This layer prevents a premature failure of the sealing arrangement as a result of a chemical attack.

### CROSS-REFERENCE TO RELATED APPLICATION

This application is a national stage application, filed under 35 U.S.C. § 371, of International Patent Application PCT/EP2023/053809, filed on Feb. 15, 2023, which claims the benefit of German Patent Application DE 10 2022 000 620.0, filed on Feb. 17, 2022.

### TECHNICAL FIELD

The disclosure relates to a sealing arrangement, in particular a mechanical seals, preferably for use in coolant units.

### BACKGROUND

In mechanical seals, the non-rotating seal ring is connected to a housing via an annular bellows. The ring bellows has a bellows section that allows axial movement of the mechanical seal ring. Particularly when mechanical seals are used in coolant units, there is the problem that the bellows part of the annular bellows is attacked by the coolant vapor in combination with the ambient air or air contained in the coolant and leads to premature failure of the mechanical seal. Due to its flexible design, the bellows section ensures that the mechanical seal ring can move axially when the mechanical seal is in use. Due to its low wall thickness, the bellows part is attacked relatively quickly by the described attack of coolant vapor and ambient air or air contained in the cooling medium to such an extent that the mechanical seal can no longer perform its sealing function.

### SUMMARY

The disclosure improves a generic sealing arrangement in such a way that it ensures a long-lasting sealing effect without any design effort.

In the disclosed sealing, at least the retaining part is provided with an airtight and/or medium-tight protective layer on its side facing the medium to be sealed and/or the air. It can cover the retaining part completely, or at least partially. In a structurally simple manner, it prevents the mounting part from being attacked by the medium to be sealed and the outside air and/or air contained in the cooling medium. In this way, chemical attack in the form of decomposition or degradation of the retaining part and thus premature failure of the sealing arrangement is avoided in a simple yet reliable manner.

The sealing arrangement is particularly suitable for use in coolant units in which the coolant must be sealed. The coolant vapors occurring during use of the coolant units, which attack the retaining part in conjunction with the ambient air and/or air contained in the coolant, are prevented from entering the retaining part by the protective layer. As a result, the coolant vapor and the ambient air and/or air contained in the coolant cannot chemically attack the mounting part in combination.

When air is generally referred to in the following with regard to the attack, this is understood to mean the ambient air and/or the air contained in the coolant.

The protective layer is advantageously a sheathing of the mounting part. The mounting part is then reliably protected from attack by the cooling medium and the outside air.

In an advantageous embodiment, the sealing element is a sealing washer that is held by the retaining part. The retaining part can be designed in such a way that it loads the sealing disk, in particular its sealing part, in the direction of the sealing position. The sealing washer is advantageously made of PTFE, which is not attacked by the cooling medium in contact with the outside air. The retaining part is usually made of elastomeric material which, without the protective layer, would be attacked by the medium to be sealed in conjunction with the air in the manner described. The protective layer prevents this attack and ensures that the sealing washer seals reliably.

In another advantageous embodiment, the sealing element has a sealing lip with a sealing edge. In this case, the retaining part is formed in one piece with the sealing element or the sealing lip. In this case, the protective layer also prevents premature failure of the sealing element due to attack by the cooling medium and air.

In a further advantageous embodiment, the sealing arrangement has a sliding ring as a sealing element, which bears under axial force with a sealing surface against a sealing surface of a rotatable counter-ring, forming a sealing gap. The sliding ring is connected to an annular bellows, which is provided with a flexible bellows part.

At least the bellows part is completely or at least partially provided with the air-and/or medium-tight protective layer on its air-and/or medium-side exterior. It prevents the bellows part from being attacked by the cooling medium in conjunction with the air. The protective layer is so thin that it does not hinder the flexibility of the bellows part.

Advantageous protection is achieved if the protective layer is a coating of the entire ring bellows. The critical bellows section is then also fully protected by the protective layer. In addition, the protective layer can simply be provided on the ring bellows in the form of a coating.

It is also possible to form the protective layer using a protective film or protective disk. It can be simply applied to the outside of the annular bellows on the air and/or medium side. Depending on the position of the protective layer on the annular bellows, the ingress of the medium to be sealed and/or air can be prevented in this way.

It is particularly advantageous here that the ring bellows can be attached to the protective film or the protective pane, for example by means of an injection molding or gluing process. This results in a secure and reliable connection between the protective layer and the ring bellows. The protective film can be very thin, for example only about 0.5 mm thick. In this case, the flexibility of the bellows part of the ring bellows is not impaired by the protective film. In addition, the protective film can be easily punched out of a film web.

A PTFE foil is advantageously used as a protective film. It ensures reliable protection of the critical areas of the ring bellows, in particular the bellows part.

In addition to PTFE, the protective film can also be made of any other suitable material that prevents the bellows section from being penetrated by the medium to be sealed and/or air.

The flexible bellows part connects a radially outer casing and a radially inner ring-shaped retaining part of the ring bellows. The bellows part is not in contact with the sliding ring, but lies at a distance from it, so that the flexibility of the bellows part is not impaired by the bellows part in the event of possible axial movements of the sliding ring.

In an advantageous embodiment, the ring bellows can be made of rubber or a rubber-like material.

If a protective film is used, it is advantageously clamped between components of the mechanical seal in the installation position. Depending on the position of the protective film on the air side or the medium side, the protective film is clamped between the annular bellows and the mechanical seal ring or the annular bellows and a plate spring as well as between the annular bellows and a housing and/or a sleeve. It sits on a radially inner area of the housing and clamps the radially inner part of the annular bellows together with it.

A protective effect can also be achieved by having an annular space between the sliding ring and the bellows part, in which there is a grease filling covering the bellows part on the medium side as a protective layer. It shields the annular space both against the entry of the medium to be sealed and against the entry of air. The grease filling fills the entire annular space so that the bellows section is reliably covered.

The counter ring is attached to a sleeve via a sleeve, with which the mechanical seal can be attached to a shaft to be sealed. The sleeve and the collar are used to attach the counter ring to the shaft. The mating ring rotates in a known manner relative to the non-rotating sliding ring.

To ensure that the sleeve is also protected from the medium to be sealed and/or the air, the sleeve is provided with an air-and medium-impermeable coating at least on its air-and medium-side exterior.

Particularly effective protection is achieved when the sleeve is completely coated with the protective layer.

The invention is explained in more detail with reference to some of the embodiments shown in the drawings.

### BRIEF DESCRIPTION OF THE DRAWINGS

FIG. 1 shows in an axial half-section a mechanical seal as a sealing arrangement according to the state of the art.

FIG. 2 shows, in a representation according to FIG. 1, a first embodiment of a sealing arrangement in the form of a mechanical seal.

FIG. 2a shows an enlarged view of a retaining sleeve of the mechanical seal according to FIG. 2.

FIG. 2b shows an enlarged view of a bellows of the mechanical seal according to FIG. 2.

FIG. 3 shows, in a representation corresponding to FIG. 2, a second embodiment of a sealing arrangement in the form of a mechanical seal.

FIG. 3a shows an enlarged view of a bellows of the mechanical seal according to FIG. 3.

FIG. 4, FIG. 4a, and FIG. 4b show, in a representations corresponding to FIGS. 2 to 2b, a third embodiment of a sealing arrangement in the form of a mechanical seal.

FIG. 5 and FIG. 5a show, in a representations corresponding to FIGS. 3 and 3a, a fourth embodiment of a sealing arrangement in the form of a mechanical seal.

FIG. 6 and FIG. 6a show, in a representations corresponding to FIGS. 3 and 3a, a fifth embodiment of a sealing arrangement in the form of a mechanical seal.

FIG. 7 and FIG. 7a show, in a representations corresponding to FIGS. 3 and 3a, a sixth embodiment of a sealing arrangement in the form of a mechanical seal,

FIG. 8, FIG. 8a, and FIG. 8b show, in a representations corresponding to FIGS. 2 to 2b, a seventh embodiment of a sealing arrangement in the form of a mechanical seal.

FIG. 9, FIG. 9a, and FIG. 9b show, in a representations corresponding to FIGS. 2 to 2b, an eighth embodiment of a sealing arrangement in the form of a mechanical seal.

FIG. 10, FIG. 10a, and FIG. 10b show, in a representations corresponding to FIGS. 2 to 2b, a ninth embodiment of a sealing arrangement in the form of a mechanical seal.

FIG. 11 shows a tenth embodiment of a sealing arrangement in the form of a mechanical seal.

FIG. 12 shows an eleventh embodiment of a sealing arrangement in the form of a mechanical seal.

FIG. 12a shows an enlarged view of a retaining sleeve of the mechanical seal according to FIG. 12.

FIG. 13 and FIG. 14 show, in the axial half-section, a twelfth and a thirteenth embodiment of a sealing arrangement in the form of a lip seal.

### DETAILED DESCRIPTION

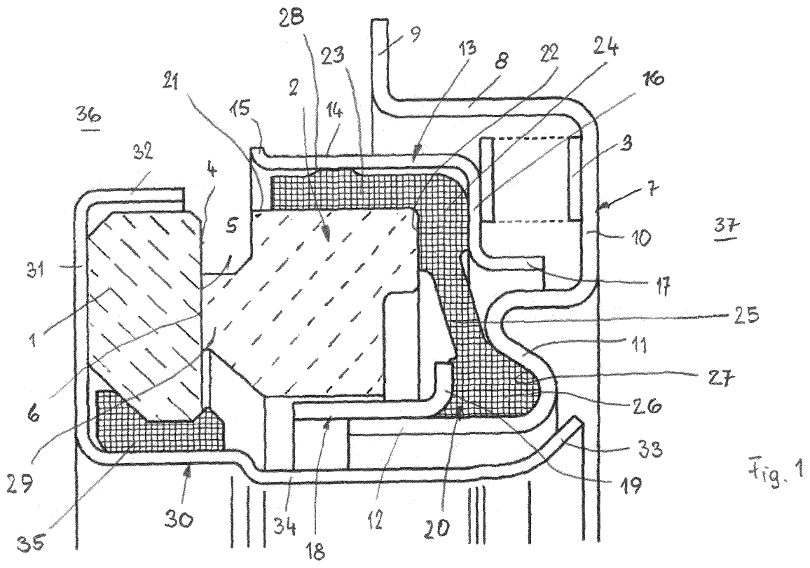

As an example of a sealing arrangement, FIG. 1 shows a conventional mechanical seal with a mating ring 1 that is non-rotatably connected to a shaft (not shown) and a sliding ring 2 that is fixed to the housing and therefore not rotatable in the installation position. Both rings 1, 2 lie against each other under the force of at least one pressure element 3 with their end faces 4, 5 forming a radial sealing gap 6.

The pressure element 3 is advantageously formed by at least one compression spring, which can be a helical compression spring or, for example, a plate spring.

One axial end of the pressure element 3 is supported on a housing 7, which is used to insert the mechanical seal into the installation space of a unit. The housing 7 has a cylindrical casing 8, the axis of which is the axis of the mechanical seal. At one end, the casing 8 merges into a radially outward-facing ring flange 9. At the other end, the casing 8 connects to a radially extending base 10, which merges into a radially inner cylindrical casing 12 via a connecting piece 11 that is bent in an approximately S-shaped axial section. It lies coaxially to the outer casing 8 and at a distance from the shaft (not shown).

The other end of the pressure element 3 is supported on a plate spring 13. It has a cylindrical casing 14, the free end 15 of which is angled radially outwards. The casing 14 merges into a radially inwardly directed base 16, which connects the cylindrical casing 14 to a radially inner cylindrical casing 17. It extends from the base 16 in the opposite direction to the casing 14.

The radially outer casing 14 partially protrudes into the housing 7 and is at a distance from the outer housing casing 8. The base 16 and the casing 17 lie inside the housing casing 8. The radially inner casing 17 is at a radial distance from the connecting piece 11 of the housing 7.

The radially inner casing 12 of the housing 7 is covered by a sleeve 18, which is pressed onto the casing 12. The sleeve 18 projects axially in the direction of the mating ring 1 over the housing casing 12. At its end facing the connecting piece 11 of the housing 7, the sleeve 18 is provided with a radially outward-facing ring flange 19. It is located at an axial distance from the connecting piece 11.

The sleeve 18 projects with radial play into the sliding ring 2, which is axially spaced from the ring flange 19 of the sleeve 18.

The sliding ring 2 is surrounded on its outside by a bellows 20, which extends over most of the axial width of the sliding ring 2 and can be clamped or firmly connected to the sliding ring.

The bellows 20 has a cylindrical casing 23 that rests on the outside 21 of the seal face 2 and merges into a radially inward-facing base 24. It covers most of the end face 22 of the sliding ring 2.

The base 24 is adjoined by a conical bellows part 25, which connects the annular base 24 to an annular retaining part 26. It fills the annular space 27 between the annular flange 19 of the sleeve 18, the radially inner housing casing 12 and the connecting piece 11 of the housing 7. The conical bellows part 25 has a reduced wall thickness compared to the other areas of the bellows 20. The bellows part 25 thus forms an elastic bending area which allows the bellows 20 to follow the axial movements of the seal face 2 with elastic deformation of the bellows part 25.

The cylindrical casing 23 and the base 24 of the bellows 20 are clamped between the sliding ring 2 and the plate spring 13. The casing 23 and the base 24 are attached in a suitable manner to the outer side 21 and the end face 22 of the sliding ring 2, such as clamped, glued or vulcanized on.

The casing 23 of the bellows 20 is provided with an annular projection 28 on its outer side, which rests against the inner side of the housing casing 14 with elastic deformation. The projection 28 is advantageously formed in one piece with the bellows 20

The housing casing 14 protrudes axially beyond the casing 23 of the bellows 20.

The sliding ring 2 projects axially beyond the housing casing 14 in the direction of the mating ring 1. Advantageously, the sliding ring 2 is provided with an annular projection 29, the end face 5 of which rests against the end face 4 of the mating ring 1.

The retaining part 26 of the bellows 20 can be clamped between the sleeve 18 and the housing 7, so that additional fastening of the retaining part 26 to the sleeve 18 and to the housing 7 is not necessary.

The annular space 27 is designed in such a way that it narrows radially outwards so that the retaining part 26 cannot move radially outwards out of the annular space 27.

The counter ring 1 is held by a fastening sleeve 30, which is fastened to the shaft (not shown). The fastening sleeve 30 has a radial flange 31 at one end that extends radially outwards and merges into a cylindrical casing 32 at the free end. It surrounds the counter ring 1 with radial clearance.

The counter ring 1 rests on the inside of the radial flange 31 of the fastening sleeve 30.

The end 33 of the fastening sleeve 30 opposite the radial flange 30 is flared in a conical shape so that the fastening sleeve 30 can simply be pushed onto the shaft when the mechanical seal is fitted.

The conically flared end 33 is at a distance from the casing 12 and the connecting piece 11 of the housing 7, so that the fastening sleeve 30 can rotate unhindered together with the shaft.

Advantageously, the fastening sleeve 30 is shaped in such a way that only part of its length is seated on the shaft, but the rest is at a distance from it. For this purpose, the fastening sleeve 30 is provided with a radially inwardly offset fastening area 34. This design allows the fastening sleeve 30 to be simply pushed onto the shaft.

The counter ring 1 is seated in the fastening sleeve 30 with an annular sleeve 35 in between. The sleeve 35 is designed so that it is elastically deformed in the installation position by the counter ring 1. The sleeve 35 is connected to the fastening sleeve 30 in a suitable manner, for example clamped to it, glued to it or vulcanized to it.

The sleeve 35 is profiled on the outside so that the counter ring 1 is secured in the axial direction of the mechanical seal.

The counter ring 1 protrudes in the direction of the sliding ring 2 over the casing 32 of the fastening sleeve 30. The counter ring 1 and the sliding ring 2 are designed and arranged in such a way that the sealing gap 6 is located in the area between the casing 32 of the fastening sleeve 30 and the casing 14 of the plate spring 13, viewed in the radial direction. The sliding ring 2 is pressed axially against the counter ring 1 under the force of the pressure element 3. The bellows 20 with its bellows part 25 enables the sliding ring 2 to perform axial movements. The bellows part 25 is elastically deformed accordingly.

In order to minimize friction in the sealing gap 6, it is advantageous to incorporate a structure (not shown) into at least one of the two end faces 4, 5, which ensures that when the counter ring 1 is rotating, the medium to be sealed forms a medium cushion in the sealing gap 6, which causes the sliding ring 2 to lift slightly from the counter ring 1 against the force of the pressure element 3. The bellows part 25 of the bellows 20 is elastically deformed accordingly. The structure in the end face 4 or 5 is designed in such a way that the medium entering the sealing gap 6 is guided back into the medium chamber 36. Structures can also be formed in such a way that they exclusively convey medium into the gap. In addition, structures that convey medium back into the medium chamber 36 can be combined with structures that convey medium into the medium chamber 36. In principle, any suitable structure can be provided to improve the friction and/or wear properties.

Another way to minimize friction in the sealing gap 6 is to form the sliding ring 1 and/or the counter ring 2 at least partially on the surface from porous material. These porosities generate a hydrodynamic force in the sealing gap 6, which leads to a reduction in friction. Sliding ring 1 and/or counter ring 2 can also consist entirely of porous material.

Such mechanical seals are often used in coolant units. The mechanical seal ensures that the coolant does not escape to the outside. In practice, it has been shown that the coolant in the coolant chamber 36 attacks the elastic bellows part 25. In conjunction with the ambient air 37 and/or the air contained in the coolant, this results in the bellows part 25 being exposed to chemical attack, which manifests itself in the bellows part 25 being decomposed or suffering degradation. The mechanical seal then fails.

Similar problems also occur in the area of the sleeve 35, which lead to premature failure of the sleeve due to the interaction of the coolant vapor and the air.

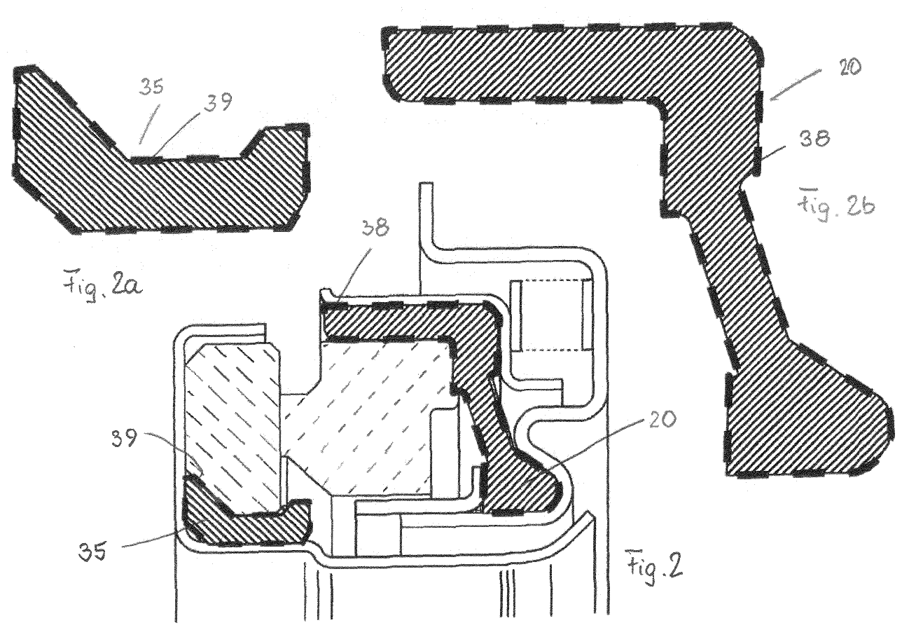

In the embodiment shown in FIGS. 2 to 2b, the bellows 20 and the sleeve 35 are completely surrounded by a coating 38, 39, which is indicated by thick dashed lines. This completely isolates the bellows 20 and the sleeve 35 from the coolant vapor or air. The coatings 38, 39 are applied in such a way that contact between the coolant vapor or the air and the bellows 20 and the sleeve 35 is prevented. The coatings 38, 39 are designed in such a way that they are impermeable or only slightly permeable to the coolant vapor or air. Advantageously, inert materials, such as PTFE-based compounds or PTFE coatings, can be considered as coating materials.

The complete sheathing of the bellows 20 and the sleeve 35 has the advantage that it can be fitted in a simple manner in terms of process engineering and ensures optimum protection against attack by coolant vapor and air.

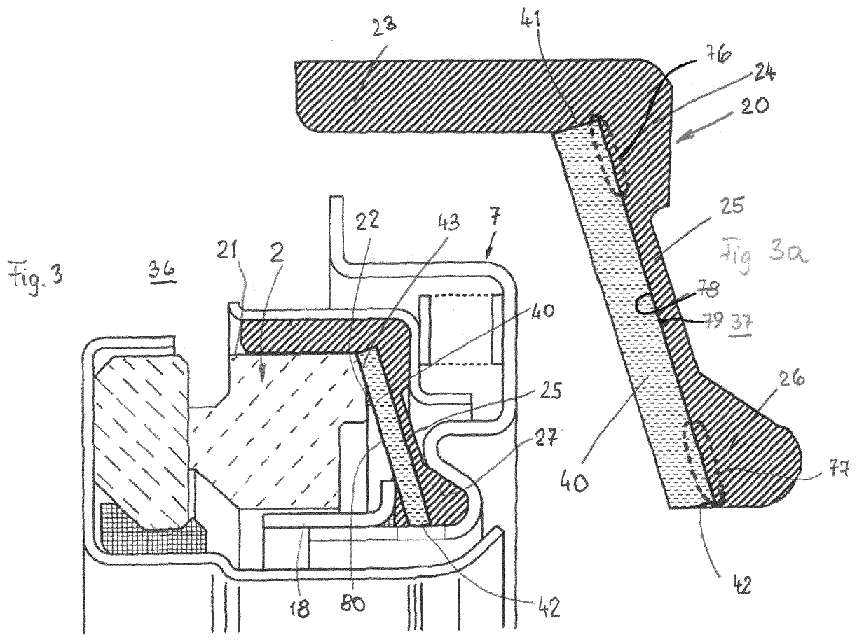

FIGS. 3 and 3a show a mechanical seal in which the critical area of the elastic bellows part 25 on the side facing the cooling medium chamber 36 is covered by an annular disk 40. It is tightly connected to the casing 23 and the retaining part 26 of the bellows 20 at least at the outer edge 41 and the inner edge 42.

In particular, the areas 76, 77 (dashed lines) marked in FIG. 3a between the side surface 78 of the annular disk 40 and the adjacent inner surface 79 of the bellows 20 in the area of the base 24 and the retaining part 26 form sealing areas which prevent the coolant vapor and air from entering the bellows part 25.

As a comparison of FIGS. 3 and 3a shows, the ring disk 40 can be covered with the material of the bellows 20 on the inner edge 42 not only on the side surface 78 (FIG. 3a), but also on the inside 80 (FIG. 3).

The annular disk 40 is advantageously made of PTFE or PTFE compounds and is conical in shape in the embodiment example. In this case, the bellows 20 is moulded onto the annular disk 40, but can also be connected to it in any other suitable manner. The bellows 20 preferably consists of an elastomer.

In contrast to the previous embodiment, the sliding ring 2 is provided with a chamfer 43 on its rear end face 22 at the transition to the outer face 21. The radially outer area of the annular disk 40 lies flat against it. However, the annular disk can also rest against the end face 22. In this case, no chamfer 43 would be required.

The radially inner area of the annular disk 40 projects into the annular space 27 between the sleeve 18 and the housing 7. The inner edge 42 of the annular disk 40 is, for example, approximately level with the inside of the sleeve 18.

The annular disk 40 is sufficiently thin so that it does not impair the bending movements of the bellows part 25 when the mechanical seal is in use.

In addition to PTFE or PTFE compounds, the annular disk 40 can also be made of other suitable inert materials.

The annular disk 40 prevents the coolant vapour from the coolant chamber 36 in combination with the air in the surrounding chamber 37 from attacking and damaging the critical bellows section 25. Since the annular disk 40 is provided on the side of the bellows 20 facing the cooling medium side 36, air can be reliably prevented from entering the bellows part 25.

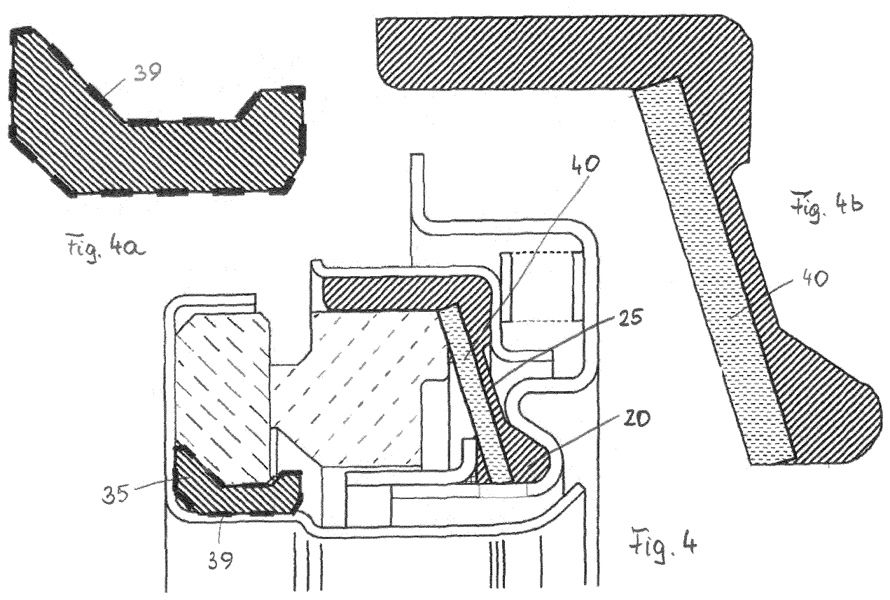

The mechanical seal according to FIGS. 4 to 4b differs from the embodiment according to FIGS. 3 and 3a in that the sleeve 35 is completely encased by the coating 39, as described for the embodiment according to FIGS. 2 to 2b. Thus, both the sleeve 35 and the bellows 20, in particular the bellows part 25, are protected against early critical attack.

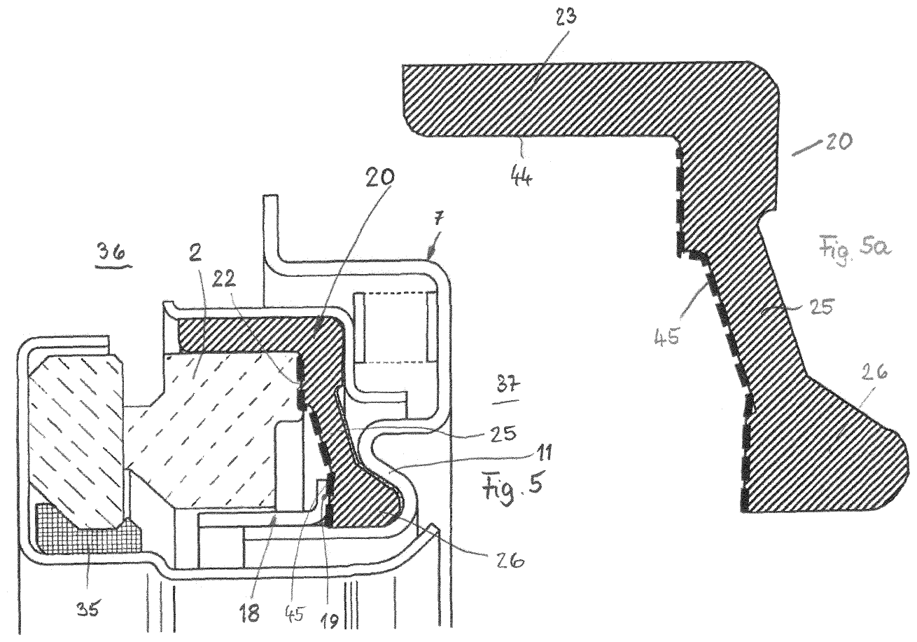

In the embodiment shown in FIGS. 5 and 5a, the bellows 20 is provided on its inner side with the coating in the form of a foil 45. It extends along the inside from the retaining part 26 to the transition to the inside of the cylindrical casing 23 of the bellows 20. The face 22 of the sliding ring 2 is in sealing contact with the radially outer area of the foil 45. The ring flange 19 of the sleeve 18 is in sealing contact with the radially inner area of the foil 45.

As the foil 45 is very thin, it does not impair the elastic mobility of the bellows section 25. In addition, it reliably ensures that neither the coolant vapor nor the air from the ambient space 37 and/or air contained in the coolant can reach the bellows section 25. The sleeve 35 has no coating.

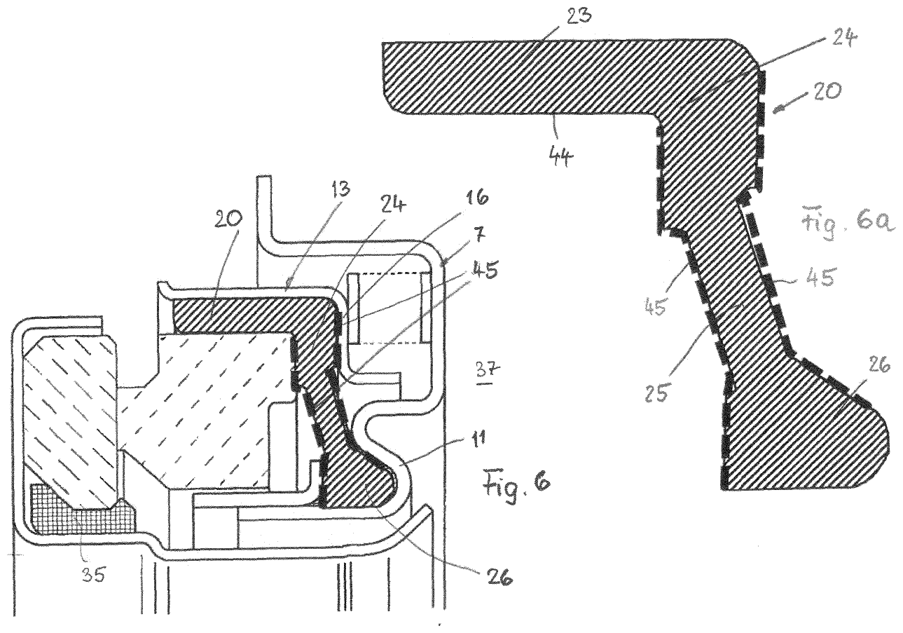

In the mechanical seal according to FIGS. 6 and 6a, the bellows 20 is provided with a coating in the form of a foil 45 not only on the inside, but also on the outside facing the surrounding space 37. On its inner side facing away from the air side 37, the bellows 20 is covered by the foil 45 from the retaining part 26 to the transition to the inner side 44 of the casing 23 of the bellows 20 in accordance with the embodiment shown in FIGS. 5, 5a.

On the air side, the foil 45 extends from the base 24 into the retaining part 26. It lies radially inwards between the retaining part 26 and the s-shaped connecting piece 11 of the housing 7 and radially outwards between the base 24 of the bellows 20 and the base 16 of the plate spring 13.

The foils ensure reliable protection of the bellows section 25 against the ingress of coolant vapor and air from the ambient space 37 and/or air contained in the coolant. The thin foils 45 do not impair the flexibility of the bellows part 25.

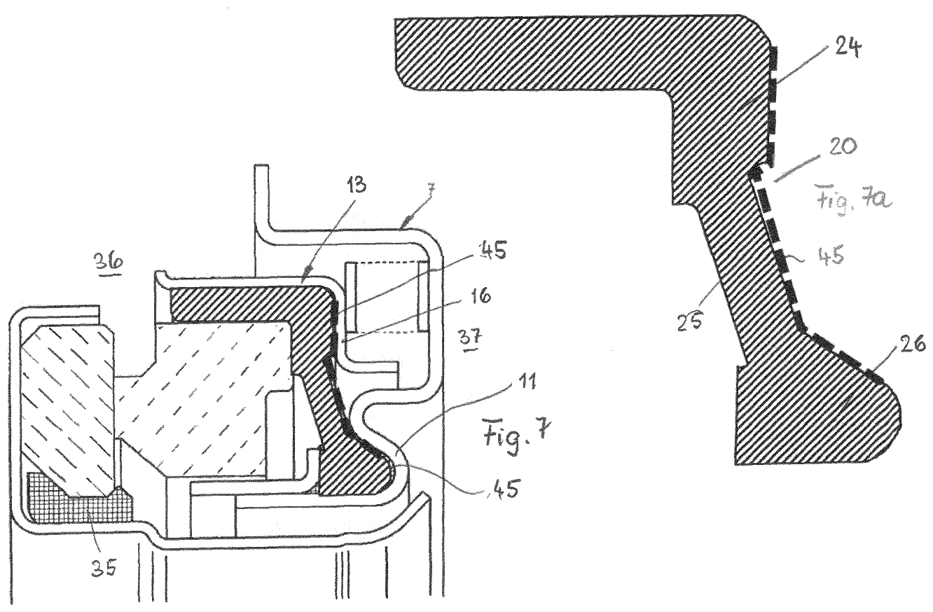

The sleeve 35 is not coated or sheathed. In the embodiment example according to FIGS. 7 and 7a, the bellows 20 is provided with the coating in the form of the foil 45 on its side facing the air side 37. It is firmly attached to the bellows 20 in a suitable manner. As in the previous embodiment, the foil 45 extends from the base 24 to the holding part 26 of the bellows 20. The foil 45 prevents the medium from accessing the bellows part 25, so that the air cannot interact with the coolant from the coolant chamber 36.

Since the foil 45 extends from the base 24 to the retaining part 26 in accordance with the previous embodiment, it is in contact with the inside of the base 16 of the plate spring 13 and the inside of the S-shaped connecting piece 11 of the housing 7 at the radially outer and radially inner area. This contributes to a secure and tight connection between the foil 45 and the bellows 20 and to perfect shielding of the bellows part 25 against the medium.

In accordance with the previous embodiment, the sleeve 35 is not sheathed or provided with a coating.

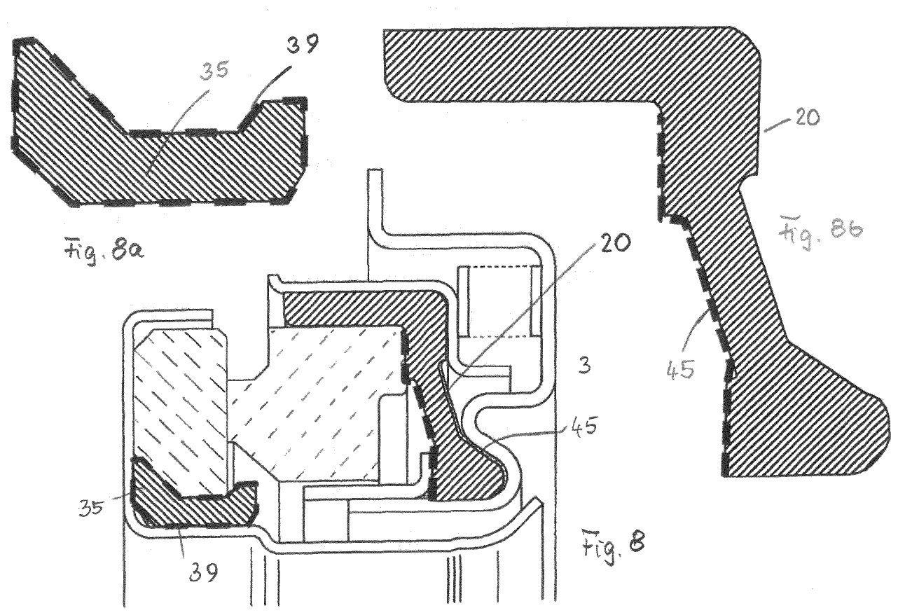

The mechanical seal shown in FIGS. 8 to 8b essentially corresponds to the embodiment shown in FIGS. 5 and 5a. The only difference is that the sleeve 35 is coated with the coating 39 in accordance with the embodiment example shown in FIGS. 2 and 2a.

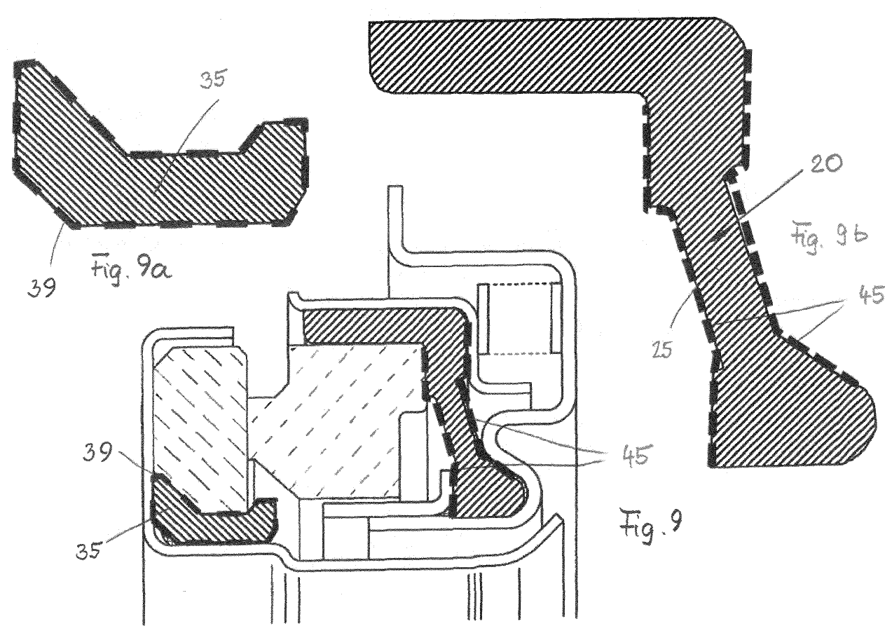

The mechanical seal according to FIGS. 9 to 9b has a bellows 20, which is provided with the foils 45 according to the embodiment according to FIGS. 6 and 6a. The sleeve 35 is designed according to the embodiment shown in FIG. 4 and 4a or 8a.

The two foils 45 on the air side and on the medium side do not impair the flexibility of the bellows section 25 and still ensure perfect shielding of the bellows section 25 from the cooling medium and from the air.

The sleeve 35 is completely covered with the coating 39 so that the sleeve is reliably protected.

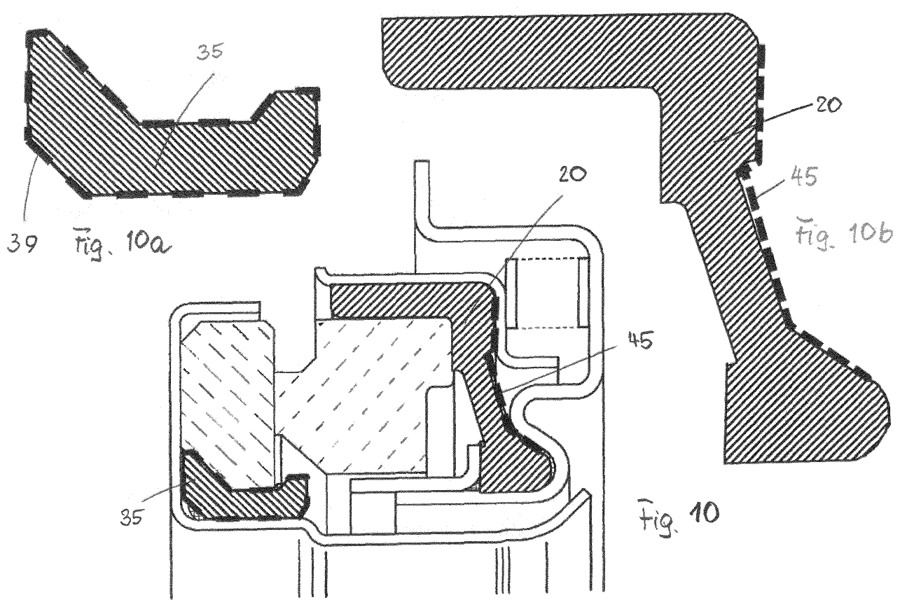

In the embodiment example shown in FIGS. 10 to 10b, the sleeve is again completely surrounded by the coating 39.

In accordance with the embodiment shown in FIGS. 7 and 7a, the bellows 20 is provided with the inserted film 45 as a coating on the side facing the air side.

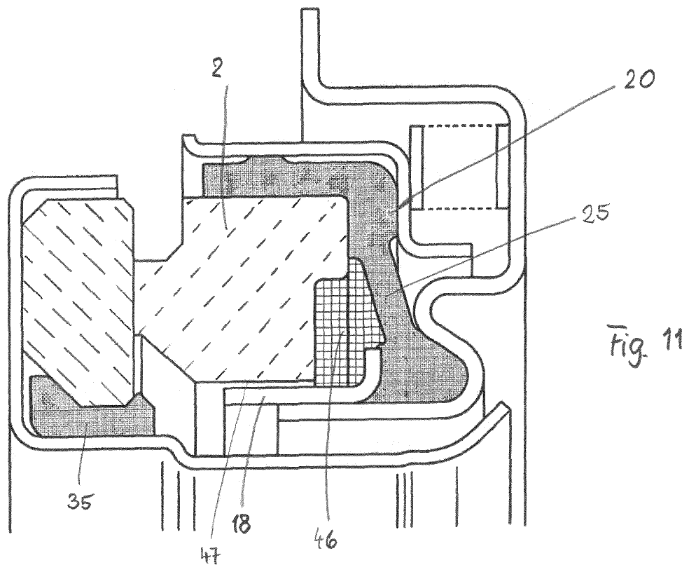

FIG. 11 shows the possibility of shielding the bellows part 25 of the bellows 20 on the air side with a grease cushion 46 as a protective layer. The fat pad 46 fills the annular space between the bellows part 25, the sliding ring 2 and the sleeve 18. The grease cushion 46 closes the axial annular gap 47 between the sleeve 18 and the sliding ring 2. In this way, the air access to the bellows part 25 can be reliably sealed. In this case, the sleeve 35 is not encased.

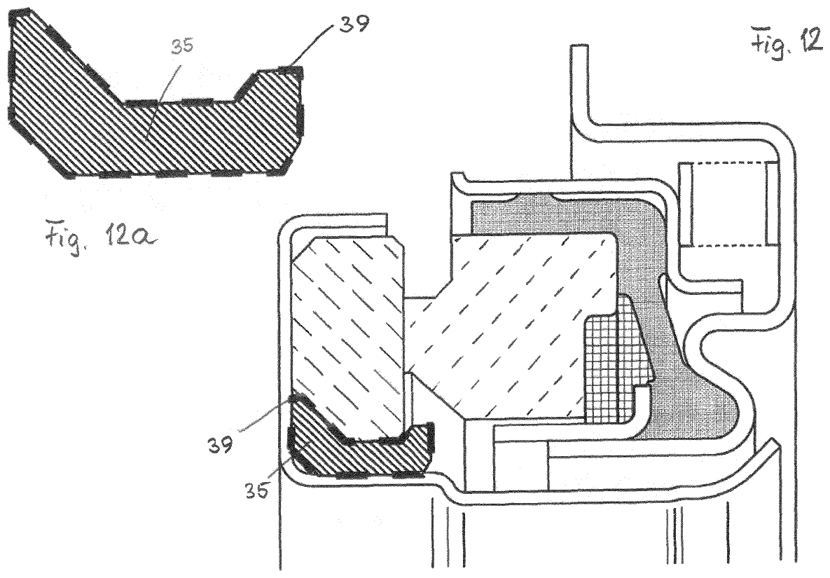

FIGS. 12 and 12a show the possibility of also covering the sleeve 35 with the coating 39 in this case.

If PTFE is used for the air-side and/or medium-side coating of the bellows 20, a PTFE foil can be used as the starting material, from which the film parts to be attached to the bellows 20 can be easily punched out.

In the embodiments shown in FIGS. 3, 3a and 4 to 4b, a hydrophobic non-woven washer can be used instead of the PTFE ring washer 40, for example. It is provided on the bellows 20 in such a way that the ingress of coolant vapor to the bellows part 25 is reliably prevented.

Since the sleeve 35 is considerably thicker than the bellows part 25 and only a small part of the sleeve 35 is exposed to the coolant vapor and the air, it may be sufficient, depending on the operating conditions, not to protect the sleeve 35, as is the case in some of the embodiments described.

The mechanical seal can be used not only in the coolant area but, as a result of the design described, wherever there is a risk that at least the bellows part 25 will be attacked by the medium to be sealed and a premature critical attack is to be feared.

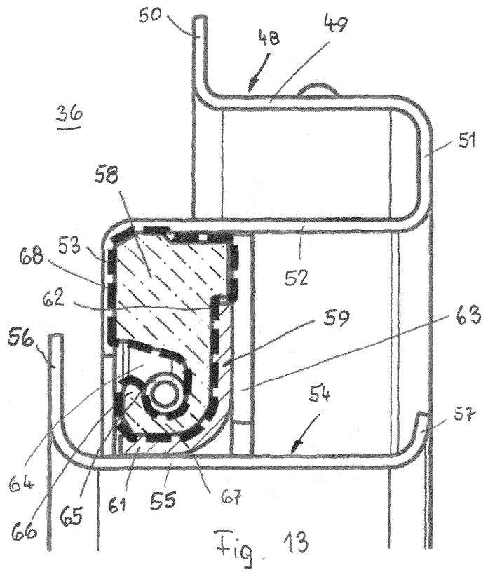

FIG. 13 shows a lip seal as an example of a sealing arrangement. It has a housing 48 with which the lip seal is pressed into an installation space of a unit. The housing 48 has an outer cylindrical casing 49, which is coaxial with the axis of the lip seal and merges at one end into a flange 50 extending radially outwards. At the other end, the casing 49 merges into a radially inwardly extending intermediate section 51, which connects the casing 49 to a radially inner cylindrical casing 52. It is also coaxial with the axis of the lip seal. At the free end, the casing 52 merges into a radially inwardly extending flange 53. The inner cylindrical casing 52 protrudes axially over the annular flange 50 of the outer casing 49.

The ring flange 53 ends at a radial distance from a sleeve 54, which sits on the shaft (not shown) in a rotationally fixed and axially immovable manner. The sleeve 54 has a cylindrical middle section 55 which sits on the shaft. At one end, the central part 55 merges into a radially outwardly directed ring flange 56. The other end 57 of the central part 55 is flared in the shape of a cone.

The ring flange 56 is axially spaced from the ring flange 53 of the housing 48. Seen in the axial direction of the lip seal, the two ring flanges 53 and 56 overlap each other.

The central part 55 of the barrel sleeve 54 projects axially beyond the cylindrical inner casing 52 of the housing 49, while the conically flared end 57 is at the level of the intermediate section 51 of the housing 48.

A retaining part 58 made of elastomeric material is located on the inside of the ring flange 53 and on the inside of the casing 52. On its side facing away from the ring flange 53, a sealing washer 59, which is advantageously made of PTFE, rests against the retaining part 58.

The sealing washer has a radially outwardly extending fastening part 60, which merges into a sealing part 61, which is formed by a radially inner, elastically curved part of the sealing washer 59 and remains sealingly on the outside of the cylindrical central part 55 of the barrel sleeve 54.

On its side facing away from the ring flange 53 of the housing 48, the retaining part 58 has a recess 62 which accommodates the fastening part 60 of the sealing washer 59. The rear side of the retaining part 58 is designed so that it lies flat against the sealing washer 59.

An annular washer 63, which lies in a radial plane of the lip seal and is held on the inside of the cylindrical casing 52 of the housing 48, serves to axially secure the retaining part 58 and the sealing washer 59. The ring disk 63 ensures that the retaining part 58 and the sealing washer 49 are held securely in their installation position.

The annular disk 63 extends from the casing 52 into the transition area of the fastening part 60 into the sealing part 61 of the sealing washer 59 and ends at a radial distance from the central part 55 of the barrel sleeve 54. This ensures that the sealing part 61 can be reliably loaded against the outside of the central part 55 of the barrel sleeve 54 by the retaining part 58.

The retaining part 58 is provided with a recess 64 on its end face facing the annular flange 53, which accommodates an annular spring 65 with which the sealing part 61 of the sealing washer 59 is loaded radially inwards against the barrel sleeve 54.

The recess 64 is designed in such a way that the annular spring 65 is limited on its side facing the annular flange 56 of the barrel sleeve 54 by a radially outwardly projecting projection 66 of the retaining part 58. As a result, the annular spring 65 is held securely in the recess 64.

The recess 64 is located, viewed in the axial direction of the lip seal, in the area between the ring flange 53 and the central part 55 of the barrel sleeve 54. The recess 64 is advantageously designed in such a way that the area 67 of the retaining part 58 located between the sealing part 61 and the retaining part 58 is thin-walled. As a result, the sealing part 61 is reliably pressed radially against the barrel sleeve 54 via the annular spring 65.

As with the mechanical seals described above, the retaining part 58 is attacked by the cooling medium in the cooling medium chamber 36 in conjunction with the outside air or air from the cooling system in the manner described. For this reason, the retaining part 58 is completely coated with the coating 68. As described with reference to the previous embodiment example, the coating 68 ensures that the cooling medium does not come into contact with the holding part 58.

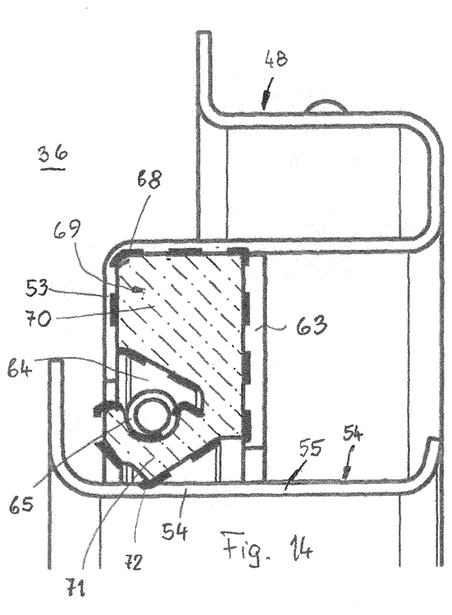

FIG. 14 shows a further embodiment of a sealing arrangement in the form of a lip seal. The housing 48 and the sleeve 54 have the same design as in the previous embodiment. The difference is that an elastomer element 69 is used as the sealing element rather than a sealing washer. It has a retaining part 70 located between the annular flange 53 of the housing 48 and the annular disk 63. A sealing lip 71 adjoins it, which rests with a sealing edge 72 on the outside of the cylindrical central part 55 of the barrel sleeve 54 under radial force. It is generated by the annular spring 65, which is arranged in the recess 64 of the sealing element 69.

It is formed in the same way as the recess in the retaining part 58 of the previous embodiment. The annular spring 65 is located at the level of the sealing edge 72, which is thus uniformly loaded over its circumference against the central part 55 of the barrel sleeve 54.

The entire sealing element 69 is coated with the coating 68 so that the medium in the cooling medium chamber 36 cannot come into contact with the sealing element 69.

Depending on the application, it may be sufficient for the coating 68 to only partially cover the retaining part 58 (FIG. 13) or the elastomer element 69 (FIG. 14), i.e. in the areas where the cooling medium can come into contact with the air.

1.-18. (canceled)

19. A sealing arrangement, comprising
a sealing element (2; 59; 71) which is held in the sealing arrangement by a retaining part (20, 58, 70),
wherein the retaining part (20, 58, 70) has an air-side and/or medium-side outer side, and
wherein the retaining part (20, 58, 70) is provided on its air-side and/or medium-side outer side with an air-tight and/or medium-tight protective layer (38, 40, 45, 46, 68), and
wherein protective layer (38, 40, 45, 46, 68) if complete or at least partial.

20. The sealing arrangement according to claim 19,
wherein the sealing arrangement is a mechanical seal configured to use in coolant units.

21. The sealing arrangement according to claim 19,
wherein the protective layer (38, 68) is a sheathing of the retaining part (20; 58).

22. The sealing arrangement according to claim 19,
wherein the sealing element (59) is a sealing washer which is held by the retaining part (58).

23. The sealing arrangement according to claim 19,
wherein the sealing element (71) is a sealing lip with a sealing edge (72).

24. The sealing arrangement according to claim 23,
wherein the sealing element (71) including the retaining part (70) is surrounded by the protective layer (68).

25. The sealing arrangement according to claim 19,
wherein the sealing element is a sliding ring (2),
wherein the sliding ring (2), under axial force, bears with a sealing surface (5) against a further sealing surface (4) of a rotatable counter-ring (1), forming a sealing gap (6), and
wherein the sliding ring (2) is connected to the retaining part (20),
wherein the retaining part (20) is designed as an annular bellows and has a flexible bellows part (25).

26. The sealing arrangement according to claim 25,
wherein at least the flexible bellows part (25) is completely or at least partially provided with the air-tight and/or medium-tight protective layer (38, 40, 45, 46) on its air-and/or medium-side outer surface.

27. The sealing arrangement according to claim 25,
wherein the protective layer (38) is a sheathing of the annular bellows (20).

28. The sealing arrangement according to claim 25,
wherein the protective layer is a protective film (45) or a protective disc (40).

29. The sealing arrangement according to claim 19,
wherein the protective layer (38, 40, 45) is formed by a PTFE foil.

30. The sealing arrangement according to claim 28,
wherein the annular bellows (20) is connected to the protective film (45) or the protective disc (40).

31. The sealing arrangement according to claim 25,
wherein the flexible bellows part (25) interconnects a radially outer casing (23) and a radially inner annular retaining part (26) of the annular bellows (20).

32. The sealing arrangement according to claim 25,
wherein the annular bellows (20) is made of rubber or rubber-like material.

33. The sealing arrangement according to claim 28,
wherein the protective film (45) is clamped
between the annular bellows (20) and the sliding ring (2) or the annular bellows (20) and a plate spring (13) as well as
between the annular bellows (20) and a housing (7) and/or a sleeve (18).

34. The sealing arrangement according to claim 25,
wherein an annular space (27) is provided between the sliding ring (2) and the flexible bellows part (25), in which annular space a grease filling (46) covering the flexible bellows part (25) on a medium side is accommodated as a protective layer.

35. The sealing arrangement according to claim 25,
wherein the counter ring (1) is seated on a fastening sleeve (30) via a sleeve (35), and
wherein the sleeve (35) can be fastened on a shaft to be sealed.

36. The sealing arrangement according to claim 35,
wherein the sleeve (35) is provided with an air-and coolant-impermeable coating (39) at least on an air-and medium-side outer side.

37. The sealing arrangement according to claim 36,
wherein the sleeve (35) is completely encased with the air-and coolant-impermeable coating (39).
